(19) United States
(12) Patent Application Publication
(10) Pub. No.: US 2019/0060915 A1
(43) Pub. Date: Feb. 28, 2019

(54) SWING-OUT CENTRIFUGE

(71) Applicant: Huawei Scientific Instruments Co., Ltd., LinHai (CN)

(72) Inventor: Wenhua Liang, LinHai (CN)

(21) Appl. No.: 15/689,819

(22) Filed: Aug. 29, 2017

(51) Int. Cl. B04B 5/04

(52) U.S. Cl. CPC B04B 5/0421

(57) ABSTRACT

A centrifuge has a hollow shell and a rotor supported by the shell. A motor is coupled to the rotor to rotate the rotor relative to the shell. Plural receptacles are formed in the rotor and respective tube holders are pivotably mounted in respective receptacles in a vertical orientation. The tube holders hold one or more test tubes containing material to be centrifuged, and the tube holders pivot within their receptacles to a horizontal orientation under the influence of spinning the rotor. The rotor can be formed with a top surface into which the receptacles are established, with the tube holders (and test tubes) being substantially completely below the top surface in the horizontal orientation to reduce friction with the air while spinning.

### FIELD

This application relates generally to swing-out centrifuges for scientific and biomedical assays.

### BACKGROUND

Scientific and biomedical assays such as for blood analysis use centrifuges to separate constituents of the material to be assayed. Many laboratory centrifuges spin tubes holding the material to be assayed with the tubes installed in the centrifuge at an oblique angle relative to horizontal, remaining at that angle before, during, and after spinning.

### SUMMARY

As understood herein, horizontal separation (i.e., with the tube or tubes held horizontally during spin) offers many advantages over separation undertaken with the tube or tubes held at a single fixed oblique-angle relative to horizontal during both spin and stop, including tighter straight-line gel separations to reduce re-spins and re-mixes. The swing-out rotor-streamline frontal area disclosed herein and high stability reduce the wind resistance effectively and also reduce the load on the centrifuge motor, which in turn reduces noise and temperature for quiet centrifuge runs while protecting the test samples.

Accordingly, an apparatus includes at least one hollow rotatable member formed with plural receptacles, and plural tube holders pivotably coupled to respective ones of the receptacles. At least some tube holders are formed with at least one tube cavity into which a respective tube that holds material for centrifuging can be disposed. The tube holders assume a vertical orientation when the rotatable member does not rotate with respective tops of the tube holders being vertically above respective bottoms of the tube holders. At least one motor is coupled to the rotatable member to rotate the rotatable member to thereby cause the tube holders to pivot in their respective receptacles to a horizontal orientation, in which the respective tops of the tube holders are radially inward of the respective bottoms of the tube holders and sheltered within the interior of the hollow rotatable member to shelter the tube holders from wind resistance when the rotatable member rotates.

In some embodiments, the rotatable member is formed with a top surface into which the receptacles are established. The tube holders are substantially completely below the top surface in the horizontal orientation as the rotatable member rotates, to reduce wind resistance. By “substantially completely below the top surface” is meant that the entire tube holder/tube structure ±10% and more preferably the entire tube holder/tube structure ±3% is completely below the top surface.

A shell may be provided to support the rotatable member. The shell may include a clamshell cover movable between an open configuration, in which the receptacles with tube holders are exposed, and a closed configuration, in which the receptacles with tube holders are covered. If desired, the clamshell cover may open automatically responsive to termination of rotation of the rotatable member.

In example implementations, at least one tube holder is pivotably coupled to a respective receptacle by opposed pins protruding radially outwardly from the tube holder and resting on respective flange surfaces formed on the rotatable member below a top surface of the rotatable member into which the receptacles are established. The opposed pins of a respective tube holder may be closer to the respective top of the tube holder than the respective bottom of the tube holder. If desired, each receptacle may include an open vertical inner side below a top surface of the rotatable member to provide clearance for the respective tube holder to pivot from the vertical orientation to the horizontal orientation.

In another aspect, a centrifuge includes a hollow shell, a rotor supported by the shell, and a motor coupled to the rotor to rotate the rotor relative to the shell. At least one receptacle is formed in the rotor. Also, at least one tube holder is pivotably mounted in the receptacle in a vertical orientation, with the tube holder pivoting to a horizontal orientation under the influence of spinning the rotor.

In another aspect, a method includes vertically disposing plural tube holders in respective receptacles of a rotor of a centrifuge with the tube holders being free to pivot in the respective receptacles. The tube holders are configured for holding one or more tubes containing material to be subject to centrifuging. The method includes coupling a motor to the rotor to spin the rotor and thereby cause the tube holders to pivot to a horizontal orientation during centrifuging.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a perspective view of a first embodiment of the centrifuge, showing six receptacles holding respective tube holders into which single, relatively large test tubes have been placed, with the tube holders in the vertical orientation owing to the rotor not spinning and with the clamshell cover of the shell in the open position;

FIG. 2 is a perspective view of a second embodiment of the centrifuge, showing eight receptacles holding respective tube holders into which single, relatively small test tubes have been placed, with the tube holders in the vertical orientation owing to the rotor not spinning and with the clamshell cover of the shell in the open position;

FIG. 3 is a perspective view of a third embodiment of the centrifuge, showing six receptacles holding respective tube holders into which four test tubes have been placed, with the tube holders in the vertical orientation owing to the rotor not spinning and with the clamshell cover of the shell in the open position;

FIG. 4 is a top plan view of the embodiment shown in FIG. 3;

FIG. 5 is a top plan view of the embodiment shown in FIG. 3, with the test tubes removed;

FIG. 6 is a bottom plan view of the embodiment shown in FIG. 3;

FIG. 7 is a side elevational view of one of the tube holders shown in FIG. 3;

FIG. 8 is a top plan view of one of the tube holders shown in FIG. 3;

FIG. 9 is a top plan view of the embodiment shown in FIG. 3, with the tube holders in the horizontal orientation owing to the rotor spinning and with the clamshell cover of the shell removed for clarity;

FIGS. 10 and 11 are elevational views of a single tube holder from the side and the front, showing the engagement between the pins of the tube holder and the sides of the slot in the rotor bowl;

FIG. 12 is an elevational view of a centrifuge consistent with present principles, showing tube holders in solid lines in the horizontal (spinning) orientation and in dashed lines in the vertical (not spinning) orientation;

FIG. 13 is a top plan view to accompany FIG. 12, showing the tube holders in the vertical orientation with an arrow to indicate the direction in which the bottoms of the tube holders move responsive to spinning the rotor;

FIG. 14 is a block diagram of certain components of a centrifuge consistent with present principles; and

FIG. 15 is a flow chart of logic consistent with present principles.

### DETAILED DESCRIPTION

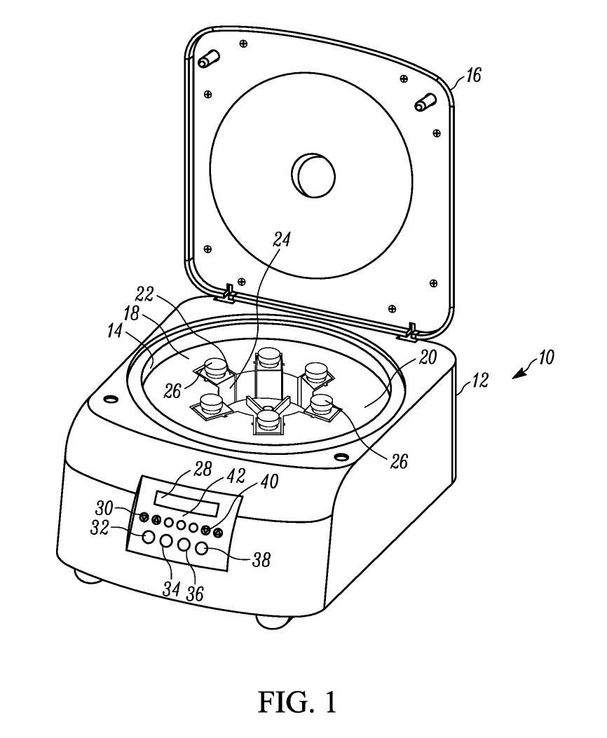

FIG. 1 shows an assembly 10 configured as a centrifuge with a generally parallelepiped-shaped hollow plastic or metal shell 12 the corners of which have been gently rounded. The shell 12 includes an open top 14 and a clamshell cover or lid 16 hingedly attached to the shell for movement between the open configuration shown, in which the open top exposes internal components to be shortly disclosed, and a closed configuration to cover the open top.

As shown, a generally cylindrical rotatable member (RM) 18 configured as a hollow rotor is disposed in the shell 12. The RM 18 is rotatably mounted in the shell 12 and can be rotated by a motor such as a brushless motor in the shell 12, shown and described below.

In the example embodiment of FIG. 1, the RM 18 is formed with a continuous top surface 20 that is interrupted only by one and preferably plural generally rectilinear-shaped receptacles 22. According to further discussion below, when the centrifuge is spinning, the motor, tube holders, and test tubes are all located below the top surface and substantially covered by the top surface (the top surface extends over and above the tube holders to essentially enclose the tube holders within the hollow RM during rotation) so as to be sheltered from wind resistance. The RM 18 may be inverted mushroom-shaped. In a non-limiting example, the rotor is formed with six receptacles 22. Each receptacle 22 is configured to closely receive a respective generally parallelepiped-shaped hollow tube holder 24 that is complementarily-shaped to the receptacle 22. In turn, each tube holder 24 includes one or more elongated tube cavities into which respective test tubes 26 can be disposed. The test tubes 26 hold material having constituents to be separated by the centrifuge.

In non-limiting implementations, the apparatus 10 may include a display 28 such as but not limited a liquid crystal display (LCD) 28 for presenting visual data pertaining to the apparatus and its operation, such as the revolutions per minute (RPM) of the rotor and time period of centrifuging. One or more time adjustment selectors 30 may be provided for manipulation by a person to increase and decrease the desired time period of centrifuging. In an example, centrifuge time may be set to be anywhere in the range of fifteen seconds to ninety-nine minutes, or indeed continuous spin until stopped by the operator.

Similarly, one or more speed adjustment selectors 32 may be provided for manipulation by a person to increase and decrease the RPM at which centrifuging takes place. In an example, the speed of centrifuging may be set to be anywhere in the range of 300 RPM-4000 RPM.

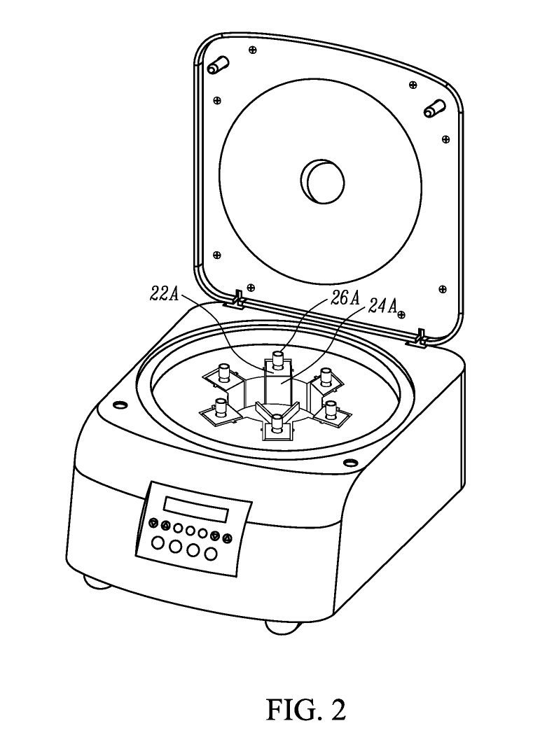

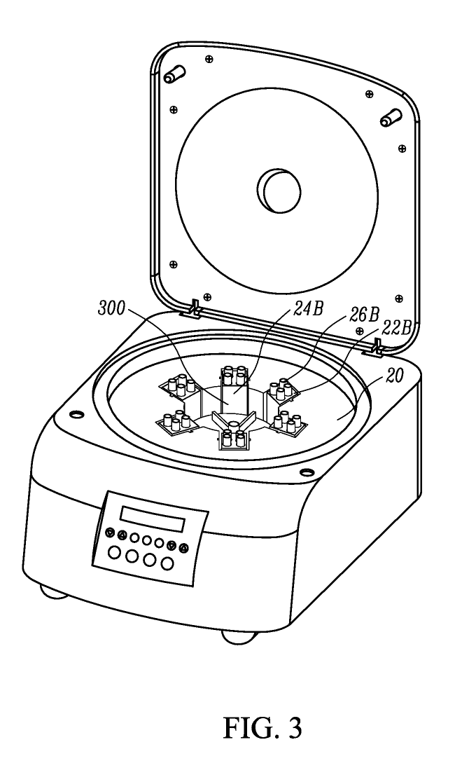

A spin selector 34 may be provided to enable a person to commence spinning the rotor by activating the motor, and a start/stop selector 36 may be provided to energize and deenergize the rotor motor and/or apparatus. The clamshell cover or lid 16 may be moved to the open position by manipulating an open selector 38. Spin speed during operation may be adjusted using speed adjustment selectors 40. One or more program selectors 42 also may be provided to access centrifuge programs and/or to establish centrifuge program parameters. In the example shown in FIG. 1, each tube holder 24 has a single tube cavity for closely receiving one and only one test tube 26 that may be a 24×10 ml/7 ml/5 ml/3 ml blood collection tube. In contrast, FIG. 2 shows an embodiment that is identical to that of FIG. 1, except that the rotor is formed with eight receptacles 22A for holding respective tube holders 24A each one of which is configured to hold a single 8×10 ml/7 ml/5 ml/3 ml blood collection tube 26A or 8×1.5 ml microtube. Yet again, FIG. 3 shows an embodiment that is identical to that of FIG. 1, except that the rotor is formed with six receptacles 22B for holding respective tube holders 24B each one of which is configured to hold plural, and in the example shown four, 24×10 ml/7 ml/5 ml/3 ml blood collection tubes 26B. In FIGS. 1-3 and specifically referring to FIG. 3 for illustration, each receptacle 22B comprises an open vertical inner side 300 below the top surface 20 of the RM 18 to provide clearance for the respective tube holder 24B to pivot from the vertical orientation shown to the horizontal orientation during centrifuging, described further below.

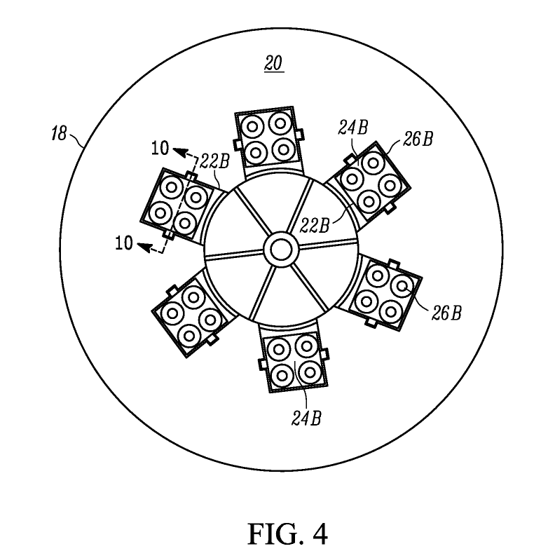

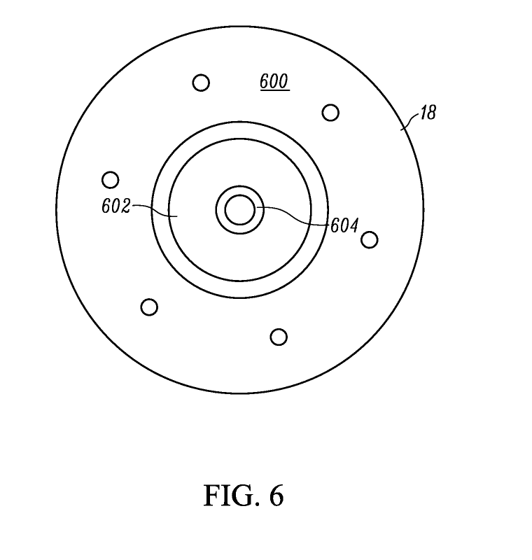

FIGS. 4-6 illustrate additional detail of the example embodiment in FIG. 3. As will be discussed further below, the tube holders 24B are pivotably coupled to respective ones of the receptacles 22B, and the tube holders 24B assume the vertical orientation shown in FIGS. 3-5 when the RM 18 does not rotate. In the vertical configuration, respective tops of the tube holders 24B are vertically above respective bottoms of the tube holders 24B as shown. On the other hand, when the RM 18 is rotated by the motor, the tube holders 24B pivot in their respective receptacles 22B to a horizontal orientation shown in figures described below, in which the respective tops of the tube holders are radially inward of the respective bottoms of the tube holders. FIG. 6 is provided to illustrate that a bottom 600 of the RM 18 is closed, with a concavity 602 configured to receive the motor that spins the RM 18 via a shaft that couples to a receptacle 604 in the RM 18.

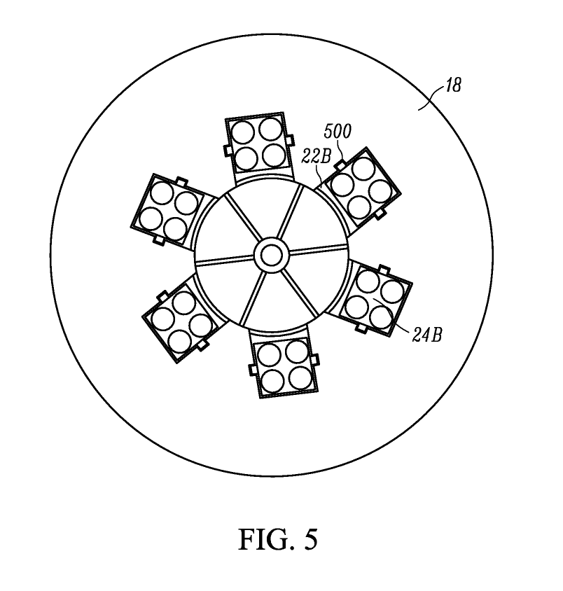

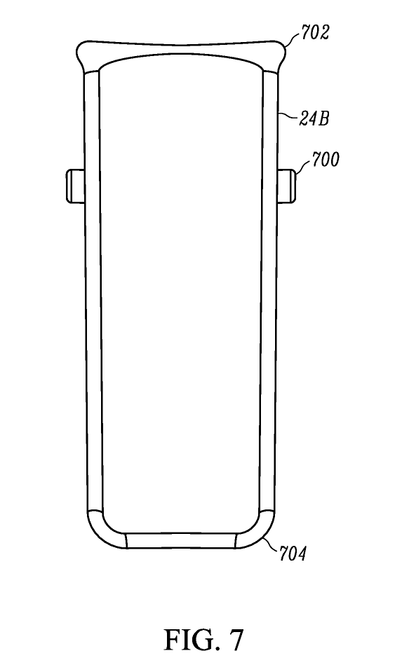

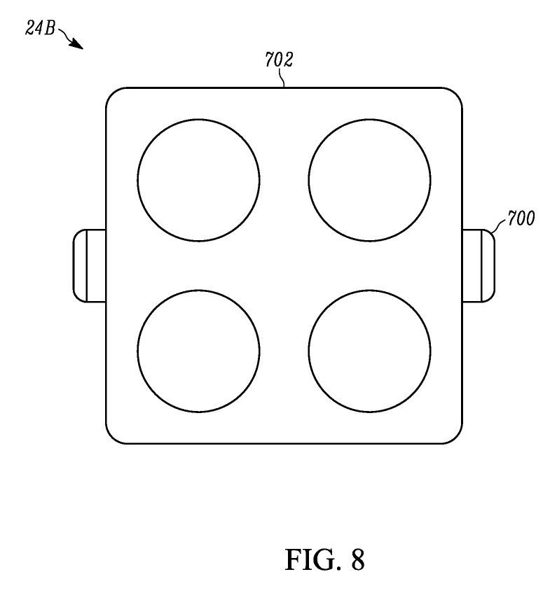

FIGS. 4, 5, 7, and 8 illustrate an example pivotable coupling between the tube holders 24B and the receptacles 22B of the RM 18. As perhaps best shown in FIG. 5, each receptacle 22B is formed with two small rectilinear openings 500 that extend radially beyond the remainder of the receptacle 22B and that are formed on opposed sides of the receptacle. As best shown in FIGS. 7 and 8, each tube holder 24B is formed with opposed pins 700 protruding radially outwardly from the tube holder and receivable in respective openings 500 of the RM 18 receptacles to rest on bottom edges of the openings which are recessed below to the top surface 20 of the rotor 18. As best shown in FIG. 7, the opposed pins 700 of a respective tube holder 24B can be closer to the respective open top 702 of the tube holder than the respective bottom 704 of the tube holder, if desired.

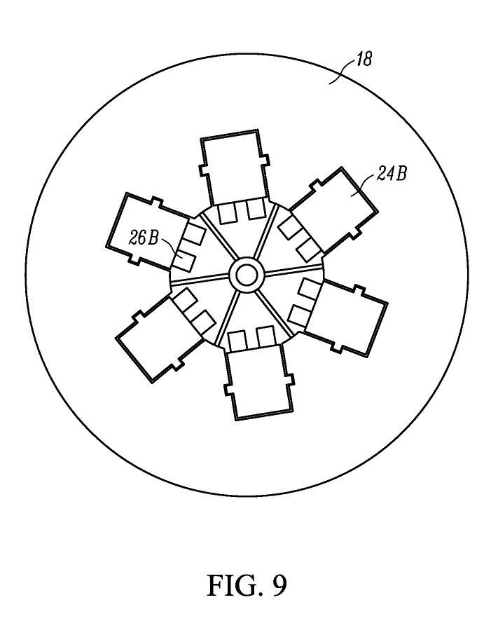

FIGS. 9-11 illustrate the cooperation of structure resulting from the pivotable engagement of the tube holders with the rotor (RM 18). In FIG. 9, the RM 18 is shown in a spinning state during centrifuging. The tube holders 24B with tubes 26B have moved ninety degrees from the vertical orientation shown in FIG. 3 to the horizontal orientation shown in FIG. 9 owing the spinning force causing the tube holders 24B to pivot about their pins 700 within their respective receptacles 22B. Because the pins 700 are closer to the top 702 than the bottom 704 of the tube holder 24B, the bottom portion of the tube holder has pivoted away from the center of the centrifuge, such that the respective tops 702 of the tube holders are radially inward of the respective bottoms 704 of the tube holders.

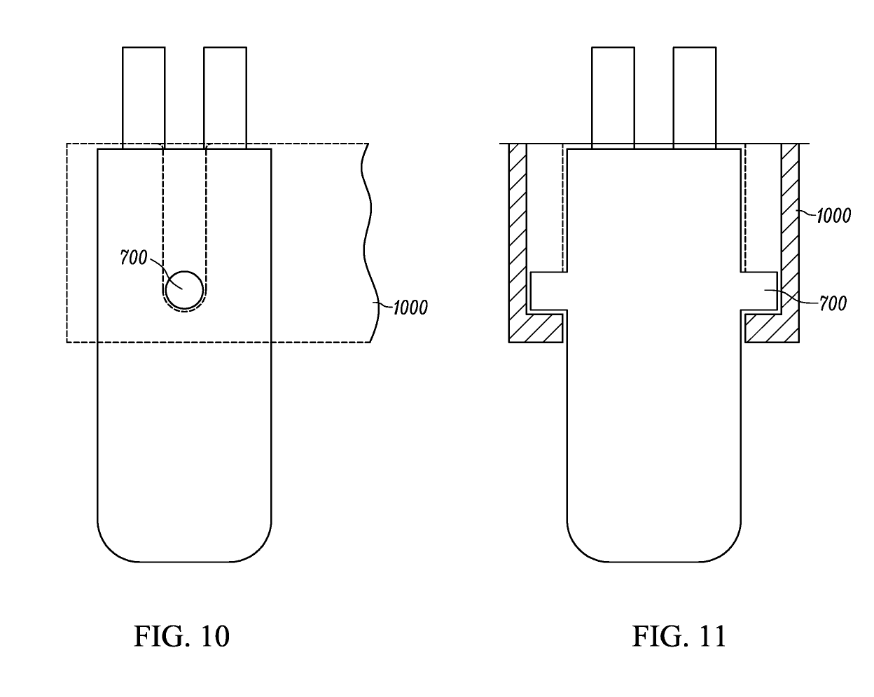

FIGS. 10 and 11 illustrate that the pins 700 of the tube holders 24B rest on respective bottom edges 1000 of the openings 500 of the generally closed top surface 20 of the RM 18 and that are formed on the RM 18 below the top surface 20 of the RM 18. The pins 700 thus are received in the openings 500 of the respective receptacles 22B to rest on the bottom edges 1000 in both the non-spinning vertical configuration and the spinning horizontal configuration, with the pins 700 rotating against the bottom edges 1000 when transitioning from vertical to horizontal and back again.

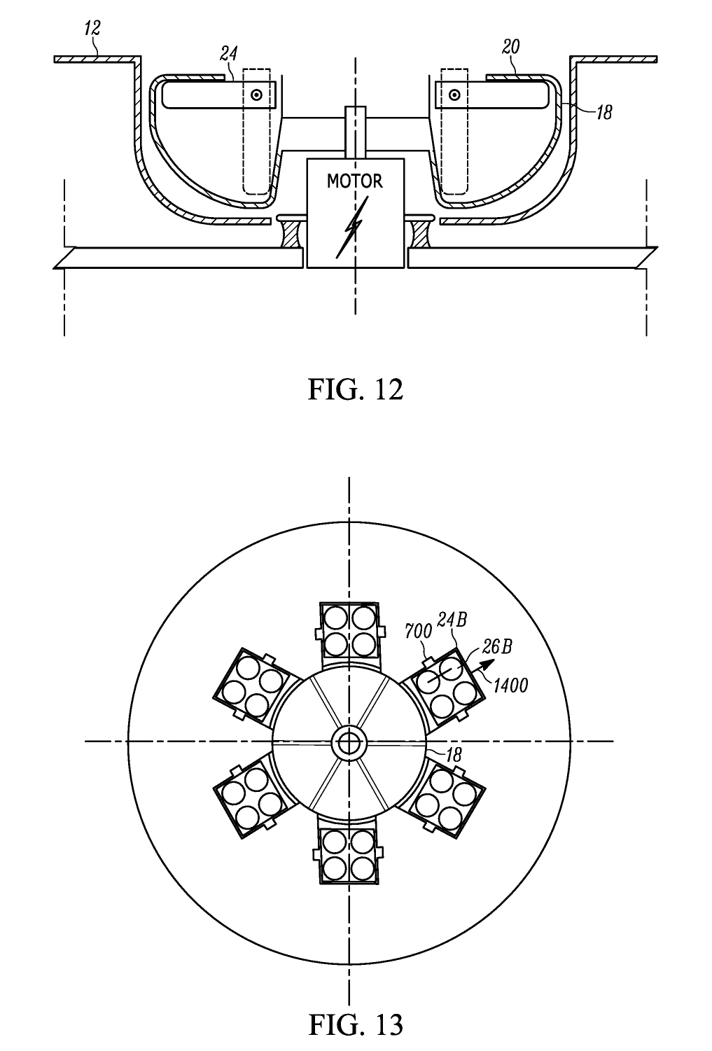

As best shown in FIG. 12, the tube holders 24B with tubes 26B are substantially completely below the top surface 20 in the horizontal orientation as the RM 18 rotates, to reduce wind resistance during centrifuging by sheltering the tube holders and tubes under the top surface 20 within the receptacles 22B. Thus, when the RM 18 rotates, the tube holders 24 are sheltered within the interior of the hollow RM 18 from wind resistance by the external walls of the RM 18 and substantially closed (except for the receptacles 22) top surface 20 of the RM 18.

Thus, FIGS. 12 and 13 are further illustrations of the above-described cooperation of structure. The elevational view in FIG. 12 shows in solid lines the tube holders 24B in the horizontal orientation during spinning of the RM 18 and in dashed lines the same holders in the vertical orientation they assume upon stoppage of spinning, in which the bottoms of the tube holders pivot back under the tops owing to the removal of the spin force. A motor 1300 is shown coupled to the RM 18 to spin the RM 18.

FIG. 13 shows the tube holders 24B with tubes 26B in the vertical orientation, illustrating by means of the arrow 1400 the direction in which the bottoms 704 of the tube holders 24B move owing to the spinning force being applied by rotating the RM 18.

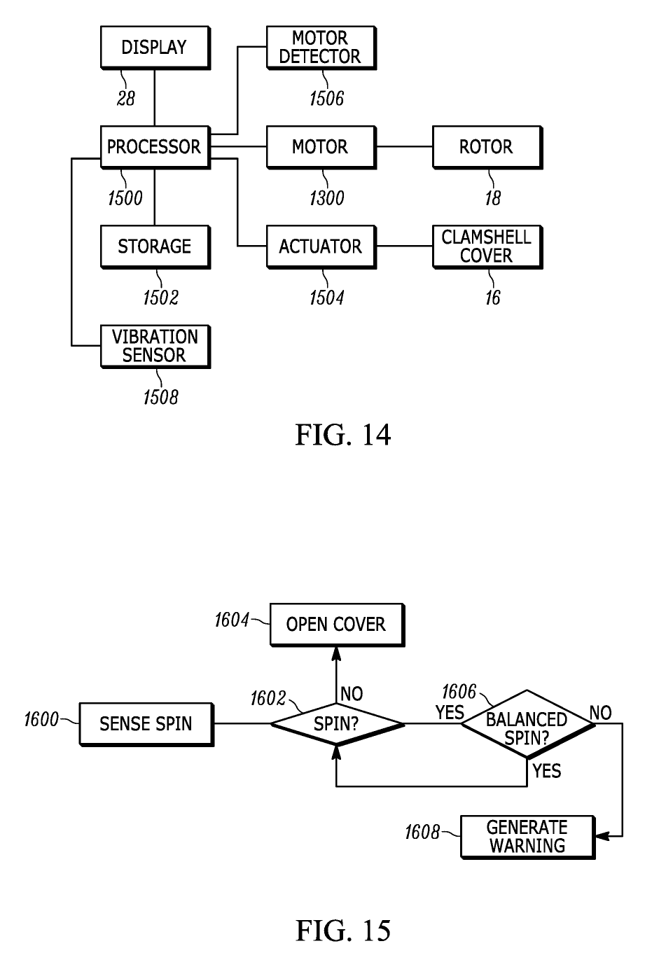

FIG. 14 illustrates example components of the assembly 10 that may be provided. A processor 1500 may access executable instructions on a computer storage 1502 to control the motor 1300 to spin the RM 18 responsive to signals received from the various controls shown in FIG. 1 and described above. The processor 1500 may also control an actuator 1504 to move the clamshell cover 16. The processor 1502 may receive indication of RM 18 motion from a motion detector 1506 such as but not limited to an accelerometer or gyroscope, and may further receive signals from a vibration sensor 1508 such as but not limited to a piezoelectric sensor or other vibration sensor.

FIG. 15 illustrates example non-limiting logic that may be executed by the processor 1500. The processor 1500 may sense spin of the RM 18 at block 1600 based on signals from the motion detector 1506. If spin is not sensed at diamond 1602, meaning that the RM 18 has stopped centrifuging rotation, the processor can control the actuator 1504 to automatically open the cover 16. If spin is sensed, the processor may proceed to diamond 1606 to determine whether the spin is balanced based on signals from the vibration sensors being, e.g., above or below a threshold amplitude. If unbalanced spin is sensed, a warning may be generated at block 1608 and output on, e.g., the display 28.

While the particular structures and methods are herein shown and described in detail, it is to be understood that the subject matter which is encompassed by the present invention is limited only by the claims.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

What is claimed is:

1. An apparatus, comprising:
at least one hollow rotatable member formed with plural receptacles;
plural tube holders pivotably coupled to respective ones of the receptacles, at least some tube holders being formed with at least one tube cavity into which a respective tube holding material can be disposed, the tube holders assuming a vertical orientation when the rotatable member does not rotate with respective tops of the tube holders being vertically above respective bottoms of the tube holders; and
at least one motor coupled to the rotatable member to rotate the rotatable member to thereby cause the tube holders to pivot in their respective receptacles to a horizontal orientation, in which the respective tops of the tube holders are radially inward of the respective bottoms of the tube holders and the tube holders are disposed within an interior of the rotatable member to shelter the tube holders from wind resistance as the rotatable member rotates.

2. The apparatus of claim 1, comprising the respective tubes.

3. The apparatus of claim 1, wherein the rotatable member is formed with a top surface into which the receptacles are established, the tube holders being substantially completely below the top surface in the horizontal orientation as the rotatable member rotates and being at least partially covered by the top surface.

4. The apparatus of claim 1, further comprising a shell supporting the rotatable member, the shell comprising a clamshell cover movable between an open configuration, wherein the receptacles with tube holders are exposed, and a closed configuration, wherein the receptacles with tube holders are covered.

5. The apparatus of claim 4, wherein the clamshell cover opens automatically responsive to termination of rotation of the rotatable member.

6. The apparatus of claim 1, wherein at least one tube holder is pivotably coupled to a respective receptacle by opposed pins protruding radially outwardly from the tube holder and resting on respective flange surfaces formed on the rotatable member below a top surface of the rotatable member into which the receptacles are established.

7. The apparatus of claim 1, wherein each receptacle comprises an open vertical inner side below a top surface of the rotatable member to provide clearance for the respective tube holder to pivot from the vertical orientation to the horizontal orientation.

8. The apparatus of claim 6, wherein the opposed pins of a respective tube holder are closer to the respective top of the tube holder than the respective bottom of the tube holder.

9. A centrifuge, comprising:
a hollow shell;
a hollow rotor supported by the shell and defining an enclosed interior;
a motor coupled to the rotor to rotate the rotor relative to the shell;
at least one receptacle formed in the rotor; and
at least one tube holder pivotably mounted in the receptacle in a vertical orientation, the tube holder pivoting to a horizontal orientation under the influence of spinning the rotor to be entirely within the interior of the rotor.

10. The centrifuge of claim 9, wherein the tube holder comprises an open top for receiving at least one respective tube therein and a closed bottom opposite the open top, the open tube being disposed radially inward of the closed bottom when the tube holder is in the horizontal configuration.

11. The centrifuge of claim 9, wherein plural receptacles are formed in the rotor for receiving respective tube holders.

12. The centrifuge of claim 9, wherein the tube holder is configured to hold one and only one tube.

13. The centrifuge of claim 9, wherein the tube holder is configured to hold plural tubes.

14. The centrifuge of claim 9, comprising at least one tube in the tube holder.

15. The centrifuge of claim 9, wherein the rotor is formed with a top surface into which the receptacles are established, the tube holders being substantially completely below the top surface in the horizontal orientation.

16. The centrifuge of claim 9, wherein the shell comprises a clamshell cover movable between an open configuration, wherein the receptacle with tube holder is exposed, and a closed configuration, wherein the receptacle with tube holder is covered.

17. The centrifuge of claim 9, wherein the tube holder is pivotably coupled to the receptacle by opposed pins protruding radially outwardly from the tube holder and resting on respective flange surfaces formed on the rotor below a top surface of the rotor.

18. The centrifuge of claim 9, wherein the receptacle comprises an open vertical inner side below a top surface of the rotor to provide clearance for the tube holder to pivot from the vertical orientation to the horizontal orientation.

19. The centrifuge of claim 17, wherein the opposed pins of the tube holder are closer to the open top of the tube holder than the closed bottom of the tube holder.

20. A method comprising:
vertically disposing plural tube holders in respective receptacles of a hollow rotor of a centrifuge with the tube holders free to pivot in the respective receptacles, the tube holders being configured for holding one or more tubes containing material to be subject to centrifuging; and
coupling a motor to the rotor to spin the rotor and thereby cause the tube holders to pivot to a horizontal orientation during centrifuging and to be enclosed within the hollow rotor.
